(19) United States
(12) Patent Application Publication
(10) Pub. No.: US 2006/0095977 A1
(43) Pub. Date: May 4, 2006

(54) Software protecting method and apparatus using the same

(75) Inventors: Su-hyun Nam, Seoul (KR); Myung-sun Kim, Uiwang-si (KR); Yong-jin Jang, Uiwang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/210,655

(22) Filed: Aug. 25, 2005

(30) Foreign Application Priority Data
Aug. 25, 2004 (KR) 10-2004-0067190

(51) Int. Cl. G06F 17/30

(52) U.S. Cl. 726/33

(57) ABSTRACT

A method and apparatus are provided for protecting software by randomly distributing software code. The software protecting method includes: dividing software code into a plurality of protecting code fields and a plurality of general code fields; selecting at least one field to be shuffled among the protecting code fields and selecting at least one seed field among the general code fields; and shuffling codes of the selected field to be shuffled according to a shuffling rule generated using a random number generator on the basis of a code value of the selected seed field.

### BACKGROUND OF THE INVENTION

This application claims priority from Korean Patent Application No. 10-2004-0067190, filed on Aug. 25, 2004 in the Korean Intellectual Property Office, the disclosure of which is incorporated herein in its entirety by reference.

1. Field of the Invention

Apparatuses and methods consistent with the present invention relate to a software protection, and more particularly, to protecting software by randomly distributing software code.

2. Description of the Related Art

Software development technologies, which have rapidly progressed due to a rapid increase in the use of computers, are now being applied to cell phones and consumer electronics (CE). According to this tendency, the software industry is progressing as an important value-added business, and copyrights of software developers are protected by law.

However, due to illegal crackers, software copyrights cannot be properly protected since software protecting technologies cannot keep up with the development speed of cracking technologies. In particular, since software is embedded in computers, CE devices, and other automatic devices, important information in software or the right to use software is illegally being cracked due to attacks of illegal crackers. Accordingly, original developers are suffering enormous losses.

### SUMMARY OF THE INVENTION

The present invention provides a method of protecting software by randomly distributing software code and an apparatus using the same.

According to an aspect of the present invention, there is provided a software protecting method comprising: dividing software code into a plurality of protecting code fields and a plurality of general code fields; selecting at least one field to be shuffled among the protecting code fields and selecting at least one seed field among the general code fields; and shuffling codes of the selected field to be shuffled according to a shuffling rule generated using a random number generator on the basis of a code value of the selected seed field.

The selecting may further comprise selecting from among the general code fields a predetermined field, into which a function for decoding the shuffled codes is inserted.

The general code fields may be divided into a plurality of smaller fields and the seed field or the predetermined field, into which the function for decoding the shuffled codes is inserted, may be selected from among the smaller fields.

A random field may be selected using the random number generator when the seed field or the predetermined field, into which the function for decoding the shuffled codes is inserted, is selected.

The shuffling rule may be used to randomly shuffle the codes of the selected field to be shuffled and randomly generated using the code value of the selected seed field as an initial value.

The random number generator may comprise a linear feedback shift register (LFSR).

According to another aspect of the present invention, there is provided a computer readable medium having recorded thereon a computer readable program for performing the software protecting method.

According to another aspect of the present invention, there is provided a software protecting apparatus comprising: a code selector dividing software code into a plurality of protecting code fields and a plurality of general code fields and selecting at least one field to be shuffled among the protecting code fields and at least one seed field among the general code fields; a shuffling rule generator generating a predetermined shuffling rule based on a code value of the selected seed field; and a code shuffler shuffling codes of the selected field to be shuffled according to the generated shuffling rule.

### BRIEF DESCRIPTION OF THE DRAWINGS

The above and other aspects of the present invention will become more apparent by describing in detail exemplary embodiments thereof with reference to the attached drawings in which:

FIG. 1 illustrates a process of shuffling software code according to an exemplary embodiment of the present invention;

FIG. 2 illustrates a process of decoding shuffled software code according to an exemplary embodiment of the present invention;

FIG. 3 is a block diagram of an apparatus for shuffling software code according to an exemplary embodiment of the present invention;

FIG. 4 illustrates an original source code before shuffling and a modified binary code after shuffling according to an exemplary embodiment of the present invention; and

FIG. 5 is a flowchart illustrating a method of shuffling software code according to an exemplary embodiment of the present invention.

### DETAILED DESCRIPTION OF THE EXEMPLARY EMBODIMENTS OF THE INVENTION

Hereinafter, the present invention will now be described more fully with reference to the accompanying drawings, in which exemplary embodiments of the invention are shown.

Shuffling indicates that a recording order of digital data is changed on a time axis when the digital data is recorded. That is, the digital data is randomly shuffled and recorded.

The present invention relates to a software protecting method using software code shuffling technology and an apparatus using the same, and has a purpose for preventing illegal crackers from accessing and analyzing software code by shuffling and randomly distributing the software code in order to protect software from attacks of the illegal crackers.

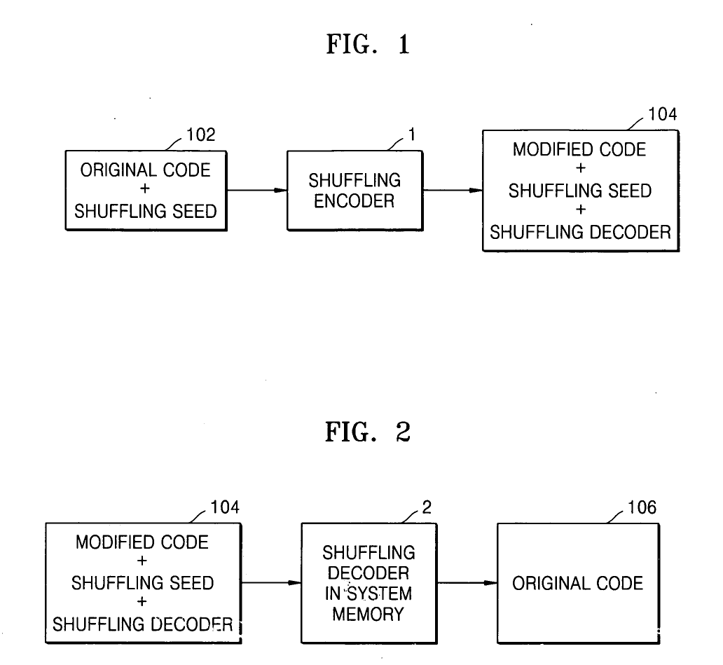

FIG. 1 illustrates a process of shuffling software code according to an exemplary embodiment of the present invention.

Referring to FIG. 1, a shuffling encoder 1 shuffles original software code 102 using a portion of the original software code 102 as a seed for shuffling. As the shuffling result, modified code, the shuffling seed used for the shuffling, and a shuffling decoder to be used when decoding (hereinafter, the modified code, the shuffling seed, and the shuffling decoder are referred to as “modified code”) 104 are output. Since the modified code 104 is randomly shuffled, the modified code 104 cannot be normally executed unless the modified code 104 is passed through a shuffling decoding process which will be described later. Therefore, access by illegal crackers can be prevented.

FIG. 2 illustrates a process of decoding shuffled software code according to an exemplary embodiment of the present invention.

Referring to FIGS. 1 and 2, the code 104 modified by the shuffling encoder 1 is loaded into a system memory (not shown) for execution. In particular, a shuffling decoder 2 for decoding the modified code 104 is included in the modified code 104 and loaded into the system memory. In the decoding, the shuffling seed included in the modified code 104 is used. As a result of the decoding, the shuffled modified code is restored to original code 106.

Here, if a portion of the modified code 104 is changed due to an attack of an illegal cracker, the value of the shuffling seed is also changed. Accordingly, the changed code is restored to a binary code that is different from the original code 106. Therefore, the original code 106 cannot be normally restored or executed.

If no attacks by illegal crackers are made on the modified code 104, a value of the shuffling seed included in the modified code 104 is not changed. Accordingly, the original code 106 can be normally restored and executed.

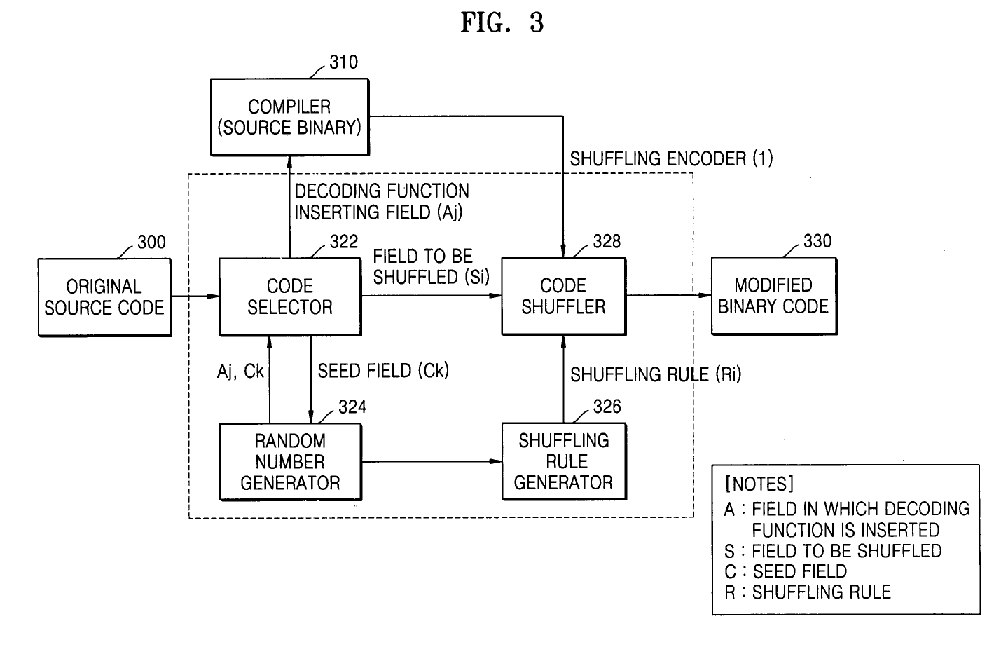

FIG. 3 is a block diagram of an apparatus for shuffling software code according to an exemplary embodiment of the present invention.

Referring to FIG. 3, the apparatus for shuffling software code, i.e., the shuffling encoder 1 shown in FIG. 1, includes a code selector 322, a random number generator 324, a shuffling rule generator 326, and a code shuffler 328.

Original source code 300, which is software code developed by a developer, is source code expressed using various languages such as C, C++, assembler, and markup languages. The original source code 300 is divided into a plurality of code fields S, which must be protected due to weakness against attacks of crackers, and a plurality of general code fields A, and information on the code division (hereinafter, code division information) is transmitted to the code selector 322. The code can be divided by being selected by a user or the shuffling apparatus. The general code fields A can be divided into a plurality of smaller fields.

The code selector 322 receives the code division information and selects fields needed for shuffling. The code selector 322 mainly performs three operations, which are described below.

First, the code selector 322 selects a field to be shuffled Si among the code field to be protected S on the basis of the received code division information. Also, the code selector 322 selects a decoding function inserting field Aj among the general code fields A. Also, the code selector 322 selects a seed field Ck, which is used as an initial value by the random number generator 324 in order to generate a shuffling rule. Here, the decoding function inserting field Aj and the seed field Ck can be randomly selected on the basis of random numbers generated by the random number generator 324. When the general code fields A are divided into a plurality of smaller fields, the decoding function inserting field Aj and the seed field Ck can be selected with at least one of the divided smaller fields.

Second, the code selector 322 inserts the shuffling decoder shown in FIG. 2, i.e., a decoding function, into the decoding function inserting field Aj with respect to the original source code 300. Also, the code selector 322 sets flags for indicating the location of the field to be shuffled Si and the location of the seed field Ck in the original source code 300. The code selector 322 transmits the original source code 300, into which the decoding function is inserted and the flags are set, to a compiler 310. The compiler 310 compiles the original source code 300 and generates binary code that a system can execute.

Third, in order to generate the shuffling rule, the code selector 322 transmits the code of the seed field Ck, which is used as an initial value by the random number generator 324, to the random number generator 324.

The random number generator 324 generates random numbers used to randomly select the decoding function inserting field Aj and the seed field Ck. Also, the random number generator 324 generates a random number used to generate a shuffling rule using the code of the seed field Ck as the initial value. For example, a linear feedback shift register (LFSR) may be used for the random number generator 324. Besides the LFSR, other kinds of random number generators 324 can be used.

The shuffling rule generator 326 generates a shuffling rule Ri based on random numbers generated by the random number generator 324. The shuffling rule Ri is used to randomly shuffle the codes of the field to be shuffled Si and is randomly generated using the code value of the seed field Ck as an initial value.

The code shuffler 328 shuffles the codes of the field to be shuffled Si by applying the shuffling rule Ri to the field to be shuffled Si. Here, the shuffling is performed with respect to the binary code compiled by the compiler 310. Accordingly, modified binary code 330 in which the code field S, which must be protected due to weakness against attacks of crackers, is randomly shuffled can be obtained. The modified binary code 330 includes the decoding function inserting field Aj, into which the decoding function is inserted, and information of the seed field Ck used as a shuffling seed when decoding.

According to the operation of the shuffling encoder 1 described above, the shuffling encoder 1 receives the original source code 300 and the code division information described above and selects the field to be shuffled Si, the decoding function inserting field Aj, and the shuffling seed field Ck using the code selector 322. The shuffling encoder 1 can select the fields Si, Aj, and Ck by receiving random numbers from the random number generator 324 and repeat the selection up to N times depending on the complexity of the software. The shuffling encoder 1 inserts a decoding function and location information of the fields Si, Aj, and Ck into the original source code 300 based on selected information and transmits the modified original source code to the compiler 310. Binary code compiled by the compiler 310 is transmitted to the code shuffler 328. The code shuffler 328 shuffles binary code of the field to be shuffled Si among the transmitted binary code according to a shuffling rule randomly generated using the code value of the shuffling seed field Ck as an initial value. The shuffling can be repeated up to a predetermined number of times.

An operation of decoding the modified binary code 330 will now be described. When the modified binary code 330 is loaded into the system memory and executed, the decoding function inserted into the decoding function inserting field Aj is automatically executed. The decoding function generates a decoding rule by generating an initial value of the random number generator 324 based on the location information of the inserted seed field Ck and field to be shuffled Si and restores codes at the location of the field to be shuffled Si to the original codes. That is, the decoding function restores the shuffled codes in the field to be shuffled Si to the original source code 300. In particular, when a run-time of the modified binary code 330 starts, only a portion needed for execution is restored, and the portion is shuffled as soon as the execution ends. Accordingly, a memory dump attack of a cracker can be prevented.

If a portion of the modified binary code 330 is changed due to an attack of an illegal cracker, a value of the shuffling seed is also changed, and the decoding rule generated on the basis of the shuffling seed value is also changed. Accordingly, the changed code is restored to binary code different from the original source code 300. Therefore, the original source code 300 cannot be normally restored or executed. If no attacks by illegal crackers are made on the modified binary code 330, a value of the shuffling seed included in the modified binary code 330 is not changed, and the generated decoding rule is not changed. That is, the original source code 300 can be normally restored and executed. Therefore, using the shuffling technology described above, attacks of illegal crackers can be prevented, and software can be protected.

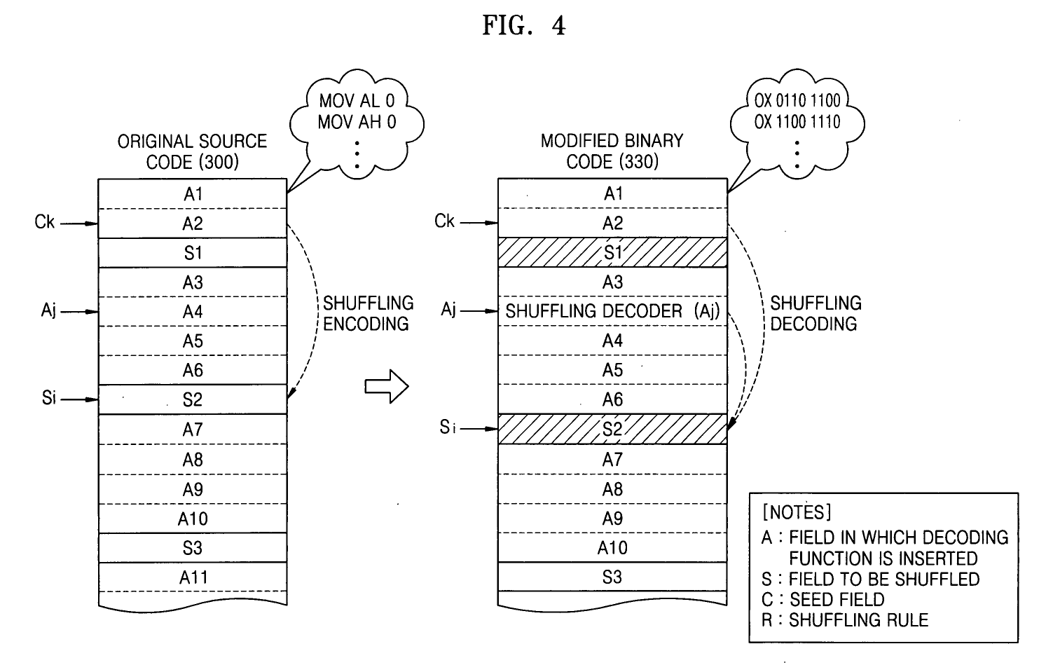

FIG. 4 illustrates the original source code 300 before shuffling and the modified binary code 330 after shuffling according to an exemplary embodiment of the present invention.

Referring to FIG. 4, an example of the original source code 300 before shuffling is shown on the left, and an example of the modified binary code 330 after shuffling is shown on the right.

The original source code 300 is divided into a plurality of code fields to be protected S and a plurality of general code fields A. Here, the general code fields A can be divided into smaller fields. The shuffling encoder 1 selects a field to be shuffled Si among the plurality of code fields to be protected S. Also, the shuffling encoder 1 selects a decoding function inserting field Aj and a seed field Ck among the general code fields A. Here, the decoding function inserting field Aj and the seed field Ck can be randomly selected on the basis of random numbers generated by the random number generator 324.

According to the example shown on the left of FIG. 4, a field S2 is selected as the field to be shuffled Si, a field A4 is selected as the decoding function inserting field Aj, and a field A2 is selected as the seed field Ck. The shuffling encoder 1 generates a shuffling rule based on a random number generated by the random number generator 324 using a code value of the field A2, which is selected as the seed field Ck, as an initial value of the random number generator 324 and inserts a decoding function used to restore shuffled fields into the field A4 selected as the decoding function inserting field Aj. Also, the modified original source code is compiled to binary code by the compiler 310. Codes of the field S2 selected as the field to be shuffled Si among the compiled binary code are randomly shuffled according to the generated shuffling rule. An example of the modified binary code 330, which is modified using the method described above, is shown on the right of FIG. 4. Each field has the same size in FIG. 4. However, the sizes of the fields can vary. Also, the shuffling can be repeated a plurality of times.

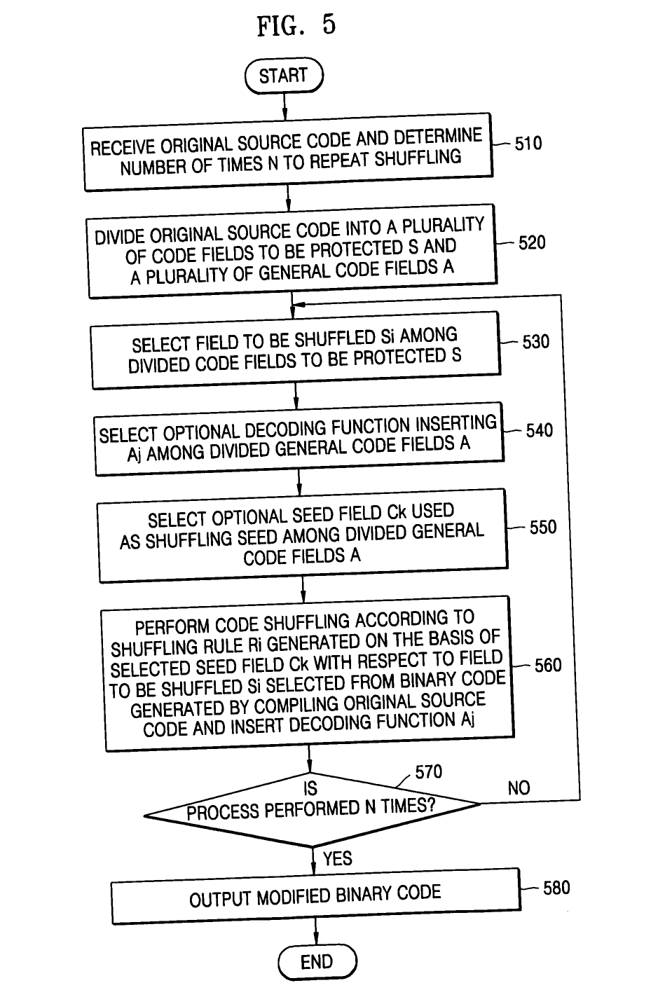

FIG. 5 is a flowchart illustrating a method of shuffling software code according to an exemplary embodiment of the present invention.

Referring to FIG. 5, the shuffling encoder 1 receives original source code and determines the number of times N to repeat shuffling in operation 510. The number of times N to repeat shuffling, for example, can be input from a developer or set by the shuffling encoder 1 according to the complexity of a program. The original source code is divided into a plurality of code fields to be protected S, which are easily attacked by illegal crackers, and a plurality of general code fields A in operation 520. A field to be shuffled Si, a decoding function inserting field Aj, and a seed field Ck, which is used as a shuffling seed, are selected among the divided fields in operations 530 through 550. Each field can be designated an optional value by the random number generator 324. The shuffling encoder 1 generates a shuffling rule Ri based on a random number generated by the random number generator 324 using the code value of the seed field Ck as the initial value. The shuffling encoder 1 receives binary code generated by compiling the original source code from a compiler and shuffles the selected field to be shuffled Si by applying the generated shuffling rule Ri to the shuffling. Also, a decoding function based on the shuffling rule Ri is inserted into the selected decoding function inserting field Aj in operation 560. Operations 530 through 560 are repeated up to a predetermined number of times in operation 570. Modified binary code in which important portions of the original source code are shuffled is output in operation 580.

As described above, according to the exemplary embodiments of the present invention, software can be protected from attacks of crackers by randomly distributing code of the software by generating random numbers using a random number generator such as an LFSR. In particular, the LFSR is used to generate pseudo random numbers, has a high processing speed and excellent performance, and guarantees better performance by changing the number of tabs or using a multi-structure.

Also, changing of original code of crackers can be prevented by selecting code fields, which are weak against attacks of crackers, e.g., a code field in which a comparison operation is performed, and generating random shuffling rules using a portion of the original code as a seed value. Because a result of an attack by a cracker changes the original code which causes a seed that is a portion of the original code to change, a wrong decoding rule is generated due to the seed change, and the original code cannot be restored.

Also, since codes shuffled according to an exemplary embodiment of the present invention leads to wrong analysis in a debugger or a disassembler that crackers mainly use, the use of the attack tool can be thoroughly blocked.

Furthermore, since a software protecting method according to an exemplary embodiment of the present invention is applied to original code divided into several fields, a memory dump attack by a cracker can be prevented. That is, the entire code must be loaded into memory in order for the memory dump attack to succeed. However, in the software protecting method, only a portion of the original code, i.e., a portion needed for execution, is restored during a run-time, and after the portion of the original code is executed, the portion of the original code is shuffled again. Accordingly, a case where the entire code exists in the memory in a restored state does not occur.

As described above, according to exemplary embodiments of the present invention, a method of protecting software by randomly distributing software code and an apparatus using the same are provided.

Accordingly, changing of original code by illegal crackers can be prevented, and software can be effectively protected from attacks made using a debugger or a disassembler or memory dump attacks.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer-readable medium having a computer-readable program code unit embodied therein for causing a number of computer systems connected via a network to effect distributed processing.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A software protecting method comprising:
dividing software code into a plurality of protecting code fields and a plurality of general code fields;
selecting at least one field to be shuffled among the protecting code fields and selecting at least one seed field among the general code fields; and
shuffling codes of the field which is selected to be shuffled according to a shuffling rule generated using a random number generator on the basis of a code value of the seed field which is selected.

2. The method of claim 1, further comprising selecting from among the general code fields a predetermined field into which a function for decoding the codes which are shuffled is inserted.

3. The method of claim 2, wherein the general code fields are divided into a plurality of smaller fields, and the seed field or the predetermined field is selected from among the smaller fields.

4. The method of claim 2, wherein at least one of the seed field or the predetermined field is randomly selected on the basis of random numbers generated by the random number generator.

5. The method of claim 1, wherein the shuffling rule is used to randomly shuffle the codes of the field which is selected to be shuffled and randomly generated using the code value of the seed field which is selected as an initial value.

6. The method of claim 1, wherein the random number generator comprises a linear feedback shift register.

7. A computer readable medium having recorded thereon a computer readable program for performing a software method comprising:
dividing software code into a plurality of protecting code fields and a plurality of general code fields;
selecting at least one field to be shuffled among the protecting code fields and selecting at least one seed field among the general code fields; and
shuffling codes of the field which is selected to be shuffled according to a shuffling rule generated using a random number generator on the basis of a code value of the seed field which is selected.

8. A software protecting apparatus comprising:
a code selector which divides software code into a plurality of protecting code fields and a plurality of general code fields, selects at least one field to be shuffled among the protecting code fields and selects at least one seed field among the general code fields;
a shuffling rule generator which generates a shuffling rule based on a code value of the seed field which is selected; and
a code shuffler which shuffles codes of the field which is selected to be shuffled according to the shuffling rule.

9. The software protecting apparatus of claim 8, wherein the code selector selects from among the general code fields a predetermined field into which a function for decoding the codes which are shuffled is inserted.

10. The software protecting apparatus of claim 9, wherein the code selector divides the general code fields into a plurality of smaller fields, and selects the seed field or the predetermined field from among the smaller fields.

11. The software protecting apparatus of claim 9, further comprising a random number generator, wherein at least one of the seed field or the predetermined field is randomly selected on the basis of random numbers generated by the random number generator.

12. The software protecting apparatus of claim 8, wherein the code shuffler randomly shuffles the codes of the field which is selected according to the shuffling rule, and the shuffle rule generator randomly generates the shuffle rule using the code value of the seed field which is selected as an initial value.

13. The software protecting apparatus of claim 11, wherein the random number generator comprises a linear feedback shift register.
